(19) United States
(12) Patent Application Publication
(10) Pub. No.: US 2026/0213394 A1
(43) Pub. Date: Jul. 23, 2026

(54) TUBE FASTENING AND KICK-BLADE TUBE RETENTION FEATURES FOR MAGNETIC MOUNTING HARDWARE

(71) Applicant: Eric Stechmann, Nixa, MO (US)

(72) Inventor: Eric Stechmann, Nixa, MO (US)

(21) Appl. No.: 19/546,880

(22) Filed: Feb. 23, 2026

Related U.S. Application Data
(63) Continuation-in-part of application No. 19/007,877, filed on Jan. 2, 2025, now Pat. No. 12,638,131.
Application No. 19/007,877 is a continuation-in-part of application No. 18/167,675, filed on Feb. 10, 2023, now Pat. No. 12,334,623.

(51) Int. Cl. H01Q 1/22; F16B 7/04

(52) U.S. Cl. CPC H01Q 1/22; F16B 7/048

(57) ABSTRACT

A tube fastening and retention system is disclosed for mounting and securing removable paddles and kick-blade tubes to a base plate. The system includes a magnetic mounting assembly having one or more trays coupled to the base plate and a plurality of magnets that releasably retain an accessory paddle. A kick-blade tube retention assembly includes a kick-blade tube having at least one tab extending from a lower edge of the tube and a base plate having at least one arcuate slot configured to receive the tab to resist lateral movement of the tube, optionally with multiple arcuate slots and lock-out tags to restrict unauthorized slot selection. A collar assembly secures a tube by opposed grip plates disposed at a longitudinal slot in the collar, with gussets and fasteners that compress the collar onto the tube and drive serrations and/or pawl grips into the tube to inhibit slippage.

### RELATED APPLICATION

This application is a continuation-in-part application of both U.S. application Ser. No. 18/167,675 filed on Feb. 10, 2023, now U.S. Pat. No. 12,334,623, issuing on Jun. 17, 2025, and U.S. application Ser. No. 19/007,877 filed on Jan. 2, 2025.

### FIELD OF THE DISCLOSURE

This disclosure relates to a magnetically mounted apparatus for securing hardware, such as telecommunications devices, to a ferromagnetic structure such as a water tower.

### BACKGROUND

Placing telecommunications antennas on top of water towers is a widely adopted practice that offers several benefits, both in terms of operational efficiency and infrastructure utilization. The use of magnetic brackets for securing these antennas further enhances these advantages. Water towers are typically tall structures designed to maximize gravity-fed water pressure, which coincidentally makes them excellent locations for telecommunications antennas. The elevation allows antennas to cover larger geographic areas, improving signal range and strength.

Using water towers eliminates the need to construct standalone towers, reducing costs and minimizing the environmental and aesthetic impact. It takes advantage of pre-existing structures, accelerating deployment timelines. Many water towers are in or near residential or urban centers where telecommunication coverage is most in demand. Combining utilities (water storage and telecommunications) optimizes the use of municipal or privately-owned infrastructure, providing economic benefits to tower owners and service providers alike. Water towers often already have municipal or regulatory approvals for their location and height, simplifying the permitting process for antenna installation.

Magnetic brackets do not require physical alterations to the water tower, such as drilling or welding, which can compromise the structural integrity of the tank or tower. Welding can create vulnerabilities in the coating of the water tower, leading to rust or other forms of corrosion. Magnetic brackets avoid this issue entirely. Magnetic brackets allow for quicker installation compared to welding, as they do not require specialized skills or equipment. Antennas can be easily repositioned or removed for maintenance without causing damage to the tower. Magnetic brackets eliminate the need for skilled welding labor and post-installation repairs or re-coating of the tower surface. Maintenance costs are reduced due to the ease of replacing or upgrading the antenna. Magnetic brackets offer a modular solution, allowing for adjustments or additions to the antenna array without permanent modifications to the tower. This flexibility is particularly valuable for accommodating future technology upgrades (e.g., 5G installations).

Installation with magnetic brackets can be completed faster than welding, minimizing disruptions to both the water utility and the telecommunications service. Avoiding welding reduces the risk of fire or heat-related accidents during installation. Magnetic brackets also reduce the need for hazardous materials or processes, aligning with sustainable practices.

The integration of telecommunications antennas on water towers using magnetic brackets represents a practical and innovative approach to modern telecommunications challenges. It maximizes the utility of existing infrastructure while maintaining the structural and operational integrity of the water tower. Furthermore, the flexibility and efficiency of magnetic brackets align with the fast-evolving needs of the telecom industry, making it a future-ready solution.

### SUMMARY

Water towers serve as ideal platforms for mounting telecommunications hardware due to their elevation and widespread distribution. However, securely attaching hardware to these structures can be challenging due to their curved surfaces, structural sensitivity, and material variability. A novel bracket system that utilizes several hundred high-strength rare-earth alloy magnets mounted on adjustable trays offers a robust solution. This system also incorporates threaded hover bolts beneath the magnets, which serve dual purposes: preventing premature attachment during installation and aiding in overcoming the magnetic force when repositioning or removing the bracket. This innovative design offers numerous benefits in adaptability, ease of installation, precision, safety, and environmental impact, making it a superior choice for modern telecommunications needs.

Disclosed herein is a collar assembly for coupling a structural tube to a structural member. The collar is configured to receive an end portion of a structural tube. The collar includes a longitudinally extending slot with opposed first and second slot edges along with a plurality of spaced apart gussets secured proximate each of the opposed first and second slot edges. The plurality of gussets, each welded at a lower edge to the surface of the collar, have a backstop surface flush with and extending upwardly from the first and second opposed slot edges. A first grip plate with a lower serrated edge, a distal end and at least one through hole is welded to the first slot edge and to the backstop surface of each of the plurality of gussets proximate the first slot edge.

A second grip plate with a lower serrated edge, a distal end, and at least one through hole that is aligned with the through hole of the first grip plate. The second grip plate is secured to the second slot edge and to the backstop surface of the plurality of gussets proximate the second slot edge. At least one fastener is passed through the at least one aligned through hole of the first and second grip plates, wherein tightening of the fastener drives the lower serrated edge of both the first and second grip plates into an outer surface of an inserted structural tube and compresses an interior surface of the collar into contact with the exterior surface of the structural tube. The disclosed system provides superior holding power and resistance to rotation as compared to, for example, U-bolt and angle iron connections.

Further disclosed is a kick-blade tube that utilizes tabs extending from the lowermost edge of the kick-blade tube that cooperate with arcuate slots in the base plate of the magnetic mounting assembly to laterally stabilize the kick-blade tube. Preferably, two oppositely disposed tabs extend downwardly from a lowermost edge of the kick-blade tube, and each tab preferably has an arc in the range of 35 to 45 degrees. The tabs extend through substantially an entire thickness of corresponding arcuate slots in the base plate with the lowermost edge resting on the base plate. The base plate preferably includes two arcuate slots to accommodate the two tabs, wherein each arcuate slot has a curvature in the range of 135 to 145 degrees. The tabs have a width slightly less than the width of the arcuate slots allowing the tabs to slide within the arcuate slots thereby allowing the entire kick-blade tube to rotate within their respective slot.

The arcuate slots in combination with the tabs extending downwardly from the lowermost edge to laterally stabilize the kick-blade tube. The arcuate slots also serve to limit placement of the kick-blade tube to one specific location thereby preventing improper placement of the kick-blade assembly. If multiple sets of arcuate slots are installed in the base plate, then lock-out tags are preferably positioned over arcuate slots that are not authorized for use based upon calculations performed by an engineer overseeing installation of the magnetic mounting hardware.

Water towers often feature curved ferro-magnetic surfaces that vary in dimensions and contours. The magnetic bracket system's use of individually adjustable trays allows precise alignment of the magnets with these surfaces. The trays can be tilted or inclined to conform to the tower's unique topography, ensuring maximum surface contact for optimal magnetic adhesion. This flexibility is particularly advantageous for irregularly shaped or aged water towers, where surface imperfections could otherwise hinder secure attachment.

By employing several hundred high-strength rare-earth alloy magnets such as those made from neodymium on each bracket, each of the brackets on a multi-bracket system, generates substantial holding power. This ensures that even under challenging conditions—such as high winds or vibrations from environmental factors—the bracket remains securely affixed to the water tower.

Traditional methods for mounting hardware on water towers, such as drilling or welding, often compromise the tower's structural integrity and protective coatings. These methods can lead to long-term issues, including rust, leaks, and costly repairs. The magnetic bracket eliminates these concerns by offering a completely non-invasive attachment method. The magnets adhere to the ferro-magnetic surface without requiring any alterations to the tower.

Additionally, threaded bolts reversibly extendable beneath the magnets prevent premature attachment during the installation process. This feature is particularly useful when handling the powerful magnets, allowing installers to position the bracket accurately before there exists contact between the magnets and the surface of the tower. This control minimizes accidental adherence that could damage the magnets, the tower's surface or even cause injury to an installer's fingers or hands.

Maintenance is equally simplified. The hover bolt design allows for easy removal and repositioning of the bracket without leaving any permanent marks or damage. This modularity is ideal for routine hardware upgrades or repairs, significantly reducing downtime and maintenance costs.

Telecommunications hardware, particularly directional antennas and signal receivers, requires precise alignment for optimal performance. The adjustable trays in the magnetic bracket enable fine-tuned orientation of the magnets, ensuring that the bracket conforms perfectly to the water tower's surface while maintaining the hardware's intended position. This capability is essential for achieving optimal signal strength and coverage.

The inclusion of hover bolts plays a critical role in repositioning. When adjustments are necessary, the hover bolts can be used to lift the magnets slightly, breaking the magnetic seal without requiring excessive manually applied force. This feature allows for controlled realignment of the bracket and attached hardware, ensuring consistent and accurate positioning over time.

Handling high-strength rare earth magnets can pose safety risks due to their powerful attraction forces. The threaded hover bolts beneath the magnets mitigate these risks by providing a mechanism for controlled engagement and disengagement. During installation, the hover bolts prevent the magnets from prematurely attaching to the water tower's surface, giving installers sufficient opportunity to position the bracket accurately.

When repositioning or removing the bracket, the hover bolts can be used to lift the magnets incrementally, reducing the effort required to overcome their holding power. This controlled release minimizes the risk of injury to workers and damage to the bracket or tower surface. By incorporating these safety features, the design enhances usability and reduces potential hazards during installation and maintenance.

The bracket system's use of rare earth magnets provides exceptional load-bearing capacity, capable of securely supporting telecommunications hardware of various sizes and weights. This robustness ensures that antennas, receivers, and other equipment remain stable even in harsh environmental conditions, such as heavy winds, rain, or ice accumulation.

The individually adjustable trays further enhance stability by ensuring uniform distribution of the magnetic force across the water tower's surface. This even distribution reduces the risk of localized stress points, which could compromise the bracket's integrity over time. Combined with the inherent durability of rare earth magnets, this system offers a reliable and long-lasting mounting solution.

One of the most significant advantages of the magnetic bracket system is its minimal environmental impact. Traditional methods, such as drilling or welding, generate debris and potentially introduce pollutants into the potable water in the water tower. These invasive techniques can also damage the water tower's protective coatings, increasing the risk of rust and structural degradation.

In contrast, the magnetic bracket preserves the tower's surface by eliminating the need for permanent modifications. The use of threaded bolts to control magnet engagement ensures that the installation process is clean and precise, further reducing the likelihood of accidental surface damage. This environmentally friendly approach aligns with modern sustainability goals and helps extend the lifespan of the water tower.

The magnetic bracket system is highly versatile, accommodating a wide range of telecommunications applications. Its modular design allows for the attachment of various types of hardware, from small antennas to large equipment arrays. The individually adjustable trays and threaded bolt mechanisms make it easy to adapt the bracket to different configurations without requiring significant redesign.

This scalability also makes the system suitable for both temporary and permanent installations. For example, during short-term projects or testing phases, the bracket can be easily removed without leaving any lasting marks on the tower. For long-term deployments, its robust construction ensures stable and reliable performance over extended periods.

The combination of ease of installation, non-invasive design, and modularity results in significant cost savings compared to traditional mounting methods. By eliminating the need for specialized tools, heavy equipment, or structural alterations, the magnetic bracket reduces initial installation costs. Its user-friendly design also minimizes labor requirements, further lowering expenses. Over the long term, the bracket's durability and adaptability contribute to ongoing savings. The ability to reposition the bracket using threaded hover bolts extends its usability, allowing it to accommodate evolving hardware needs without requiring a complete replacement. Additionally, by preserving the water tower's structural integrity, the system reduces the likelihood of costly repairs or maintenance to the tower itself.

Water towers often serve as prominent landmarks in residential or urban areas, making their appearance an important consideration. The magnetic bracket system's clean and organized design minimizes visual disruption, preserving the tower's aesthetic appeal. This is particularly valuable in communities where water towers are viewed as cultural or historical symbols.

The non-invasive nature of the system also ensures that the tower's original design remains intact, avoiding concerns over unsightly modifications or structural alterations. By balancing functionality with aesthetics, the magnetic bracket supports the dual role of water towers as infrastructure and community icons.

The magnetic bracket system for mounting telecommunications hardware to ferro-magnetic water towers represents a significant advancement in infrastructure technology. Its innovative use of high-strength rare earth magnets, adjustable trays, and threaded bolts provides unparalleled benefits in adaptability, precision, safety, and environmental preservation. By offering a non-invasive, cost-effective, and scalable solution, this system addresses the challenges of modern telecommunications installations while preserving the integrity and longevity of water towers. As a result, it stands out as a highly effective and sustainable choice for enhancing telecommunications infrastructure.

It is an object of the apparatus as disclosed herein to accommodate a wide range of telecommunications hardware for attachment to the apparatus.

Various objects, features, aspects, and advantages of the disclosed subject matter will become more apparent from the following detailed description of preferred embodiments, along with the accompanying drawings in which like numerals represent like components. The contents of this summary section are provided only as a simplified introduction to the disclosure and are not intended to be used to limit the scope of the appended claims.

The contents of this summary section are provided only as a simplified introduction to the disclosure and are not intended to be used to limit the scope of the appended claims.

### BRIEF DESCRIPTION OF THE DRAWINGS

FIG. 1 illustrates a perspective view of an embodiment of the magnetic mounting hardware secured to the surface of a water tower structure;

FIG. 2 illustrates a perspective view of an embodiment of the magnetic mounting hardware in isolation;

FIG. 3 illustrates a front elevation view of an embodiment of the magnetic mounting hardware;

FIG. 4 illustrates a bottom perspective view of the trays of an embodiment of the magnetic mounting hardware;

FIG. 4A illustrates a top perspective view of an embodiment of a single tray in isolation;

FIG. 5 illustrates a view of the hardware utilized to control the inclination of the trays relative to the base plate and to secure the trays to the base plate;

FIG. 6 illustrates a bottom perspective view of an embodiment of the plurality of magnets mounted to the bottom of a tray as well as hover bolts extending through the base plate;

FIG. 7 illustrates an assembly view of an embodiment of a magnetic disc disposed and a metal cup with threaded extension;

FIG. 8 illustrates an embodiment of the hover bolt assemblies at the edge of a tray; and

FIG. 9A illustrates a perspective view of an embodiment of the kick-blade apparatus disposed between the securement members;

FIG. 9B illustrates a perspective view of an embodiment of the kick-blade apparatus disposed in isolation;

FIG. 9C illustrates a perspective view of an embodiment of the insert pipe ready for insertion into the interior space of the kick-blade tube;

FIG. 10 illustrates a perspective view of an embodiment of the kick-blade assembly with an angle iron attached thereto;

FIG. 11 illustrates a side elevation view of an embodiment of a base plate and two laterally opposed sections;

FIG. 12 illustrates a perspective view of an embodiment of a kick-blade tube retention assembly of the magnetic mounting hardware;

FIG. 13 illustrates a perspective view of the arcuate cutouts in the base plate and lock-out tags in position over two of the cutouts;

FIG. 14 illustrates a perspective view of an embodiment of a fastening system that connects a structural tube of the roof corral to the paddle of the kick-blade assembly;

FIG. 15 illustrates an exploded perspective view of an embodiment of the collar, grip plates and grip pawls;

FIG. 16A illustrates an embodiment of a 45-degree connection between two collar devices with a stiffener plate interposed between the two collars;

FIG. 16B illustrates an embodiment of a 90-degree connection between two collar devices with a stiffener plate interposed between the two collars;

FIG. 16C illustrates a first embodiment of an accessory plate disposed between two collars;

FIG. 16D illustrates a second embodiment of an accessory plate disposed between two collars;

FIG. 16E illustrates a third embodiment of an accessory plate disposed between two collars;

FIG. 16F illustrates a fourth embodiment of an accessory plate disposed between two collars; and

FIG. 16G illustrates a fifth embodiment of an accessory plate disposed between two collars.

### DETAILED DESCRIPTION

The following description is merely exemplary in nature and does not limit the present teachings, application, or uses. Throughout this specification, reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings.

The drawings furnished are intended to illustrate and plainly disclose presently envisioned embodiments to one of skill in the art but are not intended to be manufacturing level drawings or renditions of final products and may include simplified conceptual views to facilitate understanding or explanation. Also, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the order discussed or illustrated, unless specifically identified as an order of performance. It is also to be understood that additional or alternative steps can be employed.

When an element, object, device, module, apparatus, component, region or section, etc., is referred to as being “on”, “engaged to or with”, “connected to or with”, or “coupled to or with” another element, object, device, module, apparatus, component, region or section, etc., it can be directly on, engaged, connected or coupled to or with the other element, object, device, module, apparatus, component, region or section, etc., or intervening elements, objects, devices, modules, apparatuses, components, regions or sections, etc., can be present. In contrast, when an element, object, device, module, apparatus, component, region or section, etc., is referred to as being “directly on”, “directly engaged to”, “directly connected to”, or “directly coupled to” another element, object, device, module, apparatus, component, region or section, etc., there may be no intervening elements, objects, devices, modules, apparatuses, components, regions or sections, etc., present. Other words used to describe the relationship between elements, objects, devices, modules, apparatuses, components, regions, or sections, etc., should be interpreted in a like fashion (e.g., “between” versus “directly between,” “adjacent” versus “directly adjacent,” etc.).

As used herein the phrase “operably connected to” will be understood to mean two are more elements, objects, devices, modules, apparatuses, components, etc., that are directly or indirectly connected to each other in an operational and/or cooperative manner such that operation or function of at least one of the elements, objects, devices, modules, apparatuses, components, etc., imparts or causes operation or function of at least one other of the elements, objects, devices, modules, apparatuses, components, etc. Such imparting or causing of operation or function can be unilateral or bilateral.

As used herein, the term “and/or” includes all combinations of one or more of the associated listed items. For example, A and/or B includes A alone, or B alone, or both A and B. Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Although the terms first, second, third, etc., can be used herein to describe various elements, objects, devices, modules, apparatuses, components, regions, or sections, etc., these elements, objects, devices, modules, apparatuses, components, regions, or sections, etc., should not be limited by these terms. These terms may be used only to distinguish one element, object, device, module, apparatus, component, region, or section, etc., from another element, object, device, module, apparatus, component, region, or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because varying and different embodiments may be made within the scope of the concept(s) taught herein, and because many modifications may be made in the embodiments described herein, it is to be understood that the details herein are to be interpreted as illustrative and non-limiting.

The disclosed apparatus is directed to magnetic mounting hardware that is highly adaptable to the topography of the surface of a structure that is fabricated from a ferromagnetic material. The close alignment of the magnetic mounting hardware coupled with substantial magnetic holding power yields magnetic mounting hardware that is capable of restraining multiple telecommunications hardware components atop a water tower even when subject to powerful wind and seismic events.

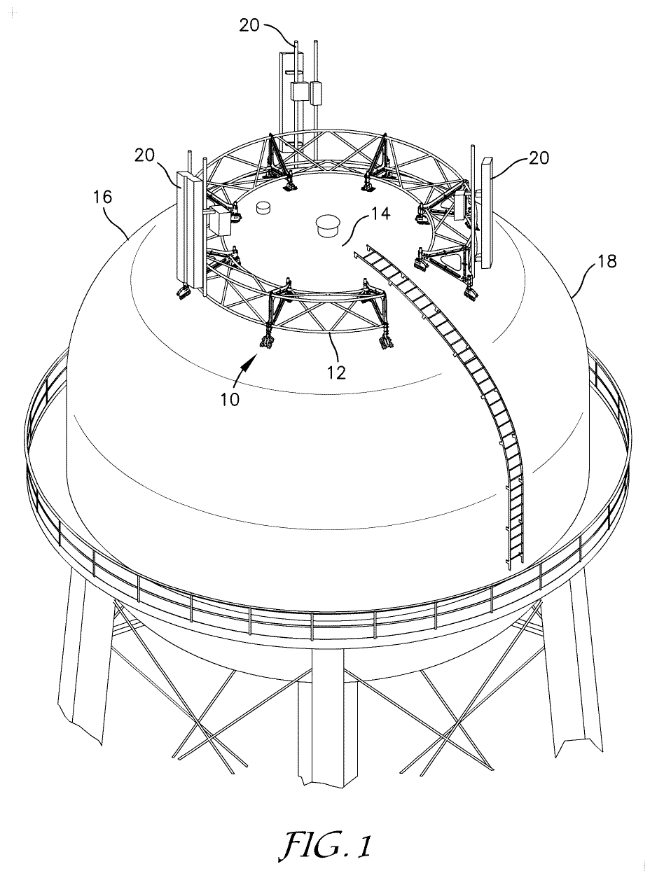

FIG. 1 illustrates an embodiment of the magnetic mounting assembly 10 in use to restrain an embodiment of a roof corral 12 to the upper surface 14 of a water tower 16. The water tower 16 upper surface 14 and side walls 18 are fabricated from ferro-magnetic material to facilitate attachment of the magnetic mounting assembly 10. The roof corral 12 as disclosed at FIG. 1 is supporting various hardware components 20 consisting of telecommunications equipment such as transmitters, receivers, GPS, backup power sources, and base receiver stations among other types of hardware.

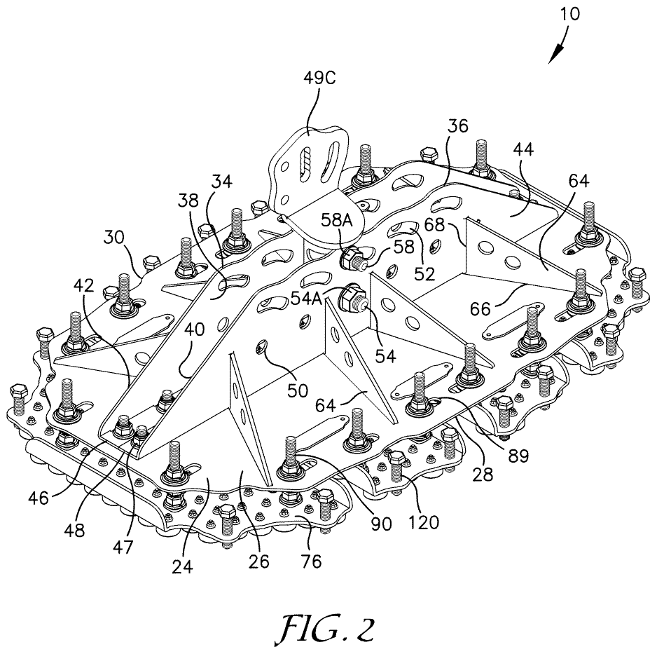

FIG. 2 illustrates an embodiment of the magnetic mounting assembly 10 in isolation for securing the hardware components 20 to the ferro-magnetic upper surface 14 of the water tower 16. The magnetic mounting hardware 10 includes a base plate 24 with an upper surface 26, a lower surface 28 and a circumferential surface 30. The base plate 24 is preferably fabricated from non-magnetic stainless-steel and has a nominal thickness of approximately 0.25 inches. Non-magnetic stainless-steel types, such as those with an austenitic crystal structure, are greatly preferred in the fabrication of the magnetic mounting hardware 10 because the powerful magnets utilized by the hardware 10 are not attracted to the base plate 24 or any of the other components utilized in the fabrication of the hardware 10.

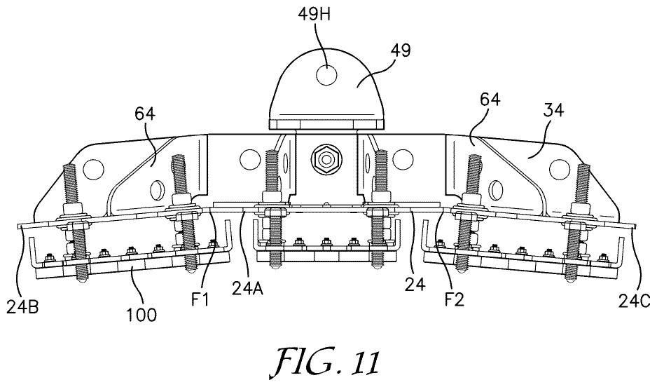

The thickness of the base plate 24 may vary from one embodiment to the next depending upon the loads that are anticipated due primarily to the number and weight of the telecommunications hardware components 20. The base plate 24 may be flat or alternatively as illustrated at FIG. 11, segregated into two or more inline non-coplanar sections to include a center section 24A, and first and second lateral sections 24B, 24C. The side segments are each bent downward along fold lines F1, F2. The bend is preferably in the range of about 5 degrees and facilitates tangential contact with the topography of the structure to which the magnetic mounting hardware 10 is to be applied. This slight downward bend of each section 24B, 24C enhances the ability of the magnets 100 to maintain maximum surface contact with the structure to which the magnets 100 are mounted.

In an alternative embodiment to enhance the alignment of the magnets with the surface of the structure, the magnetic mounting assembly 10 includes a center base plate 24A, a plurality of magnets 100 coupled to the center base plate 24A and configured to magnetically secure the apparatus to a ferromagnetic structure. The magnetic mounting assembly 10 also includes first and second lateral sections 24B, 24C each with their own collection of attached magnets 100, positioned on opposite sides of the center base plate 24A.

The magnetic mounting assembly 10 is configured such that the center base plate 24A and the first and second lateral sections 24B, 24C collectively form a continuous curved profile having no distinct angular transition between the center base plate 24A and each lateral section 24B, 24C. It is contemplated that additional sections beyond only a single lateral section on each side of the base plate 24A may also be employed should the holding power of the magnetic mounting assembly 10 so require.

The base plate 24 and lateral sections 24B, 24C are preferably mechanically reconfigured before any stiffening hardware such as securement members 34, 36 or stiffener plates 64 are added to the base plate 24. Attempting to bend the base plate 24 when the stiffening members are already welded in position may damage the welds and/or plastically deform the metal.

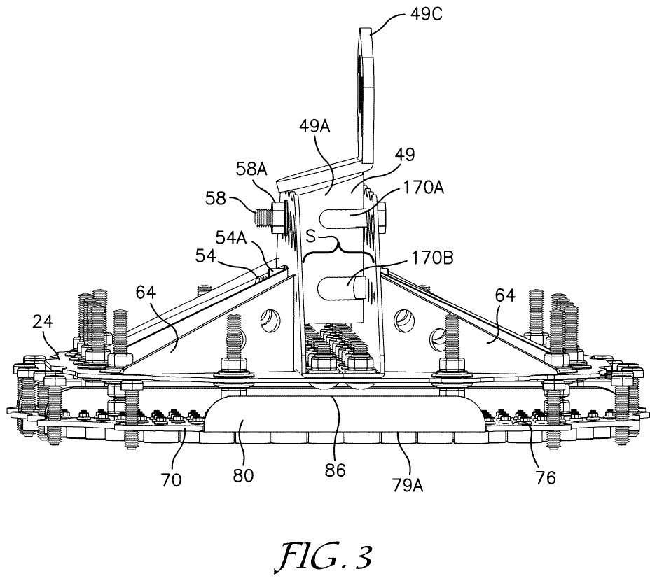

As further illustrated at FIG. 2, the magnetic mounting hardware 10 includes a spaced apart pair of securement members 34, 36 mounted substantially perpendicular to the upper surface 26 of the base plate 24. Each of the securement members 34, 36 includes an inner face 38, 40 and an outer face 42, 44. The lower flanges 46, 48 of each of the securement members 34, 36 are preferably secured to the upper surface 26 of the base plate 24 with fasteners 47. As illustrated at FIG. 3, the spacing S between the securement members 34, 36 is dependent upon the kick-blade assembly 49 that is positioned between the securement members.

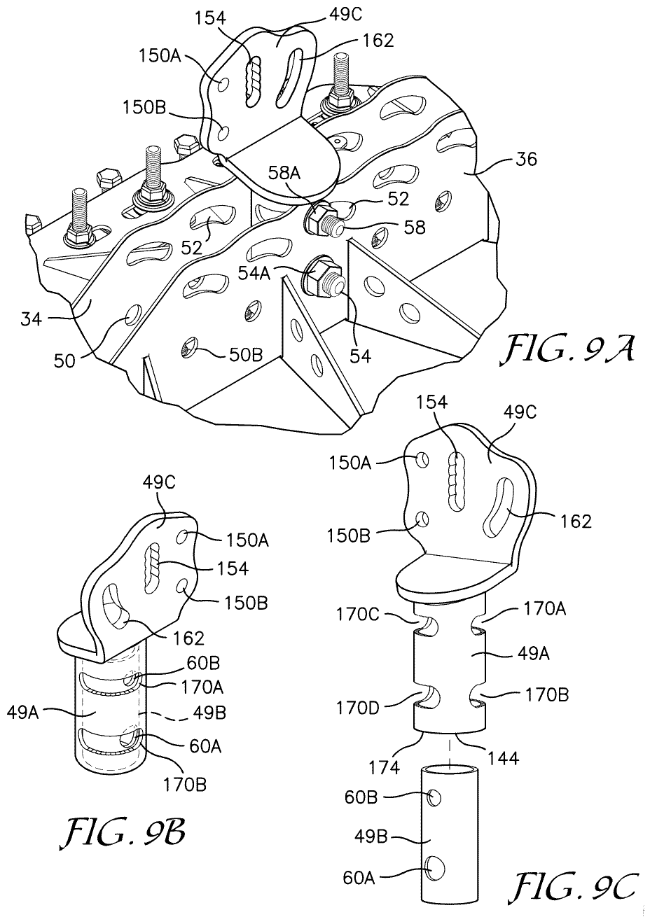

The kick-blade assembly 49 includes the kick-blade tube 49A, an insert pipe 49B (as best illustrated at FIG. 9B) and the paddle 49C. The minimum required diameter and wall thickness of the kick-blade tube 49A is confirmed by calculating the total load from the roof corral assembly 12 along with the weight of the telecommunication hardware components 20. The kick-blade assembly 49 must be sufficiently robust to support the combined weight of the roof corral 12 and the hardware components 20 without either elastically or plastically deforming when considering intense dynamic loads that may be applied by powerful wind or seismic induced events.

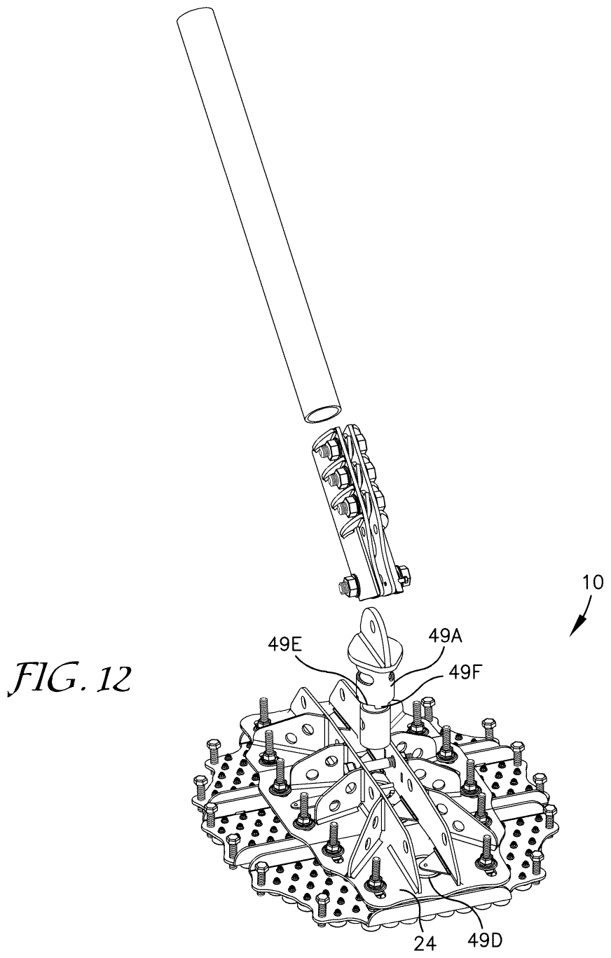

In the disclosed system and as illustrated at FIG. 12, a kick-blade tube retention assembly of the magnetic mounting assembly 10 includes a base plate 24 defining at least one arcuate slot 49D, and a kick-blade tube 49A having a lowermost edge 49E with at least one tab 49F extending downwardly therefrom. The tabs preferably have an arc range from about 35- to 45-degrees. The tab 49F is received within the arcuate slot 49D, which preferably has an arc in the 135- to 145-degree range, such that the slot and tab cooperate to enhance the lateral stability of the kick-blade tube 49A as against the base plate 24. Lateral stability refers to the ability of the kick-blade tube 49A to resist twisting (torsion), swaying, or shear forces that act perpendicular to the tube's longitudinal axis. The tabs 49F and slot 49D act as a mechanical guide, locking the components together to prevent lateral movement.

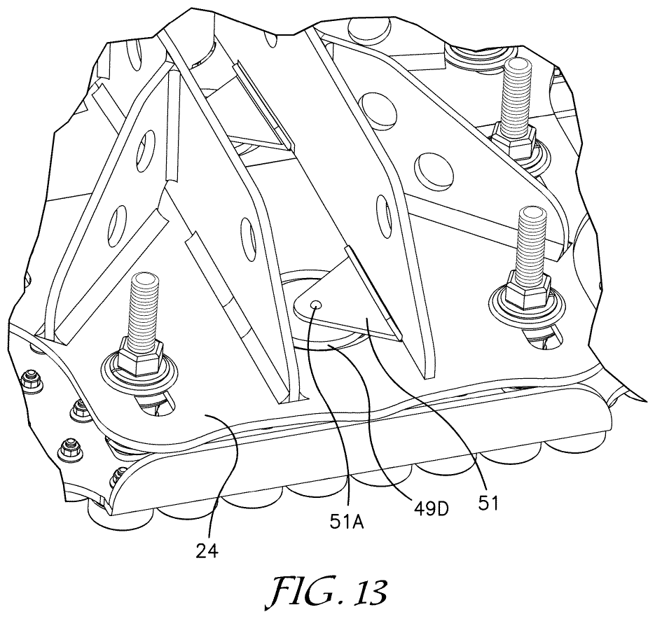

As illustrated at FIG. 13, the kick-blade tube retention assembly may include multiple sets of arcuate slots 49D in the base plate 24. When multiple sets of arcuate slots 49D are present in the base plate 24, lock-out tags 51 may be positioned over one or more of the arcuate slots 49D that are not authorized for use based upon specifications issued by the engineer overseeing installation of the magnetic mounting system. The reusable lock-out tags 51 are positioned to prevent the insertion of the tabs 49F into the arcuate slots 49D effectively forcing the installer to only use slots 49D that are not shielded by the tags 51.

The tags 51 are preferably metallic, such as aluminum and shaped in a triangular (warning) configuration and are preferably coated with a high contrast color relative to the base plate to further highlight the critical nature of the lock out tag. In a preferred embodiment the lock out tags have a cautionary note printed or embossed onto the tag admonishing the installer that the tag may only be removed by an authorized individual. The lock out tags 51 are preferably secured in place with a threaded fastener 51A that is anchored into the base plate 24 and has a thickness that is sufficient to prohibit the kick-blade tube 49A from being received into the arcuate slots 49D.

The securement members 34, 36, as illustrated at FIG. 2, also each include at least one through hole 50, 50B disposed beneath at least one slot 52. The at least one through holes 50, 50B are sized and positioned to secure the kick-blade assembly 49 between the securement members 34, 36 with the lower end proximate the base plate 24. As best understood by viewing FIGS. 2, 9B and 9C, a fastener 54 is passed through the first securement member 34 then through slots 170B, 170D in the kick-blade tube 49A, openings 60A in the insert pipe 49B and finally through the second securement member 36 where preferably a nut 54A is threaded onto the fastener 54 preventing the fastener 54 from withdrawing from the securement members 34, 36 and the kick-blade assembly 49.

A preferred embodiment of the magnetic mounting hardware includes between two and ten through holes 50 in each of the securement members 34, 36 thereby providing considerable flexibility in positioning the kick-blade assembly 49 within the space S between the securement members 34, 36. The sizing of the through holes 50 and openings 60A and slots 170B, 170D are dependent upon the anticipated loads applied to the fastener 54 by the roof corral 12 and associated telecommunications equipment 20.

As illustrated at FIGS. 2 and 3, the at least one slot 52 is preferably arcuate in configuration to facilitate some movement of the magnetic mounting hardware 10 relative to the kick-blade assembly 49. This movement enables optimal placement of the magnetic mounting hardware 10 upon the upper surface 14 of the water tower 16. A fastener 58 is passed through the at least one slot 52 of the first securement member 34 through slots 170A, 170C in the kick-blade tube 49A openings 60B in the insert pipe 49B (see FIGS. 9B and 9C) and then through the second slot 52 in the second securement member 36 where preferably a nut 58A is threaded onto the fastener 58 preventing the fastener from withdrawing from the securement members 34, 36 and kick-blade assembly 49A. A preferred embodiment of the magnetic mounting hardware 10 includes between two and ten slots 52 in each of the securement members 34, 36. The sizing of the slots 52, 170A, 170C and openings 60B are dependent upon the anticipated loads applied to the fastener 58 by the roof corral 12 and the associated telecommunications equipment 20.

As illustrated at FIGS. 2 and 3, at least one stiffener plate 64 is disposed against the outer face 42, 44 of each of the securement members 34, 36 and the base plate 24 to restrain against undesired bending or flexing of the securement members. A preferred embodiment of the stiffener plates 64 is triangular in configuration. The lower edges 166 and the side edges 68 of the stiffener plates 64 are preferably welded respectively to the upper surface 26 of the base plate 24 and the outer faces 42, 44 of the securement members 34, 36. The stiffener plates 64 are preferably fabricated from stainless steel and of sufficient thickness to prevent buckling of the securement members 34, 36. In a preferred embodiment a total of four stiffener plates are utilized per securement member 34, 36.

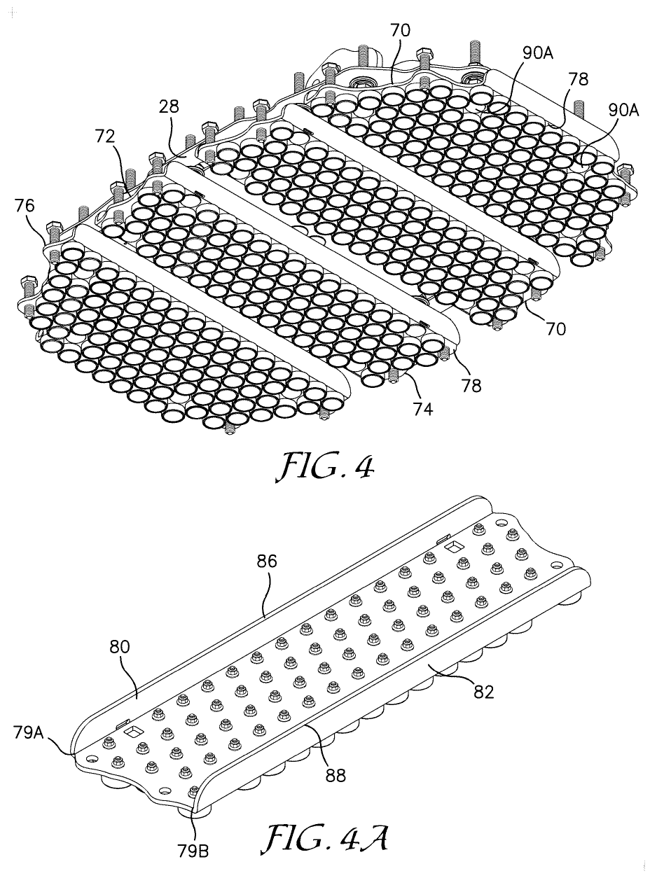

As illustrated at FIG. 4, disposed beneath the lower surface 28 of the base plate 24 are a plurality of trays 70 spaced apart from one another and from the lower surface of the base plate. Mounted to the base plate 24 the spaced apart trays 70 each include a first longitudinal end 72, a second longitudinal end 74, an upper surface 76 and a lower surface 78. The first and second longitudinal ends 72, 74 of each of the trays 70 extends roughly consistent with the circumferential surface 30 of the base plate 24. As illustrated at FIG. 4A, extending upwardly from the laterally oppose outer edges 79A, 79B of each of the plurality of trays 70 are upwardly extending flanges 80, 82 that terminate at upper edges 86, 88. These upwardly extending flanges 80, 82 serve to further enhance the stiffness of the trays 70 preventing inadvertent bending of the trays under loads applied by the roof corral 12 and associated telecommunications hardware 20.

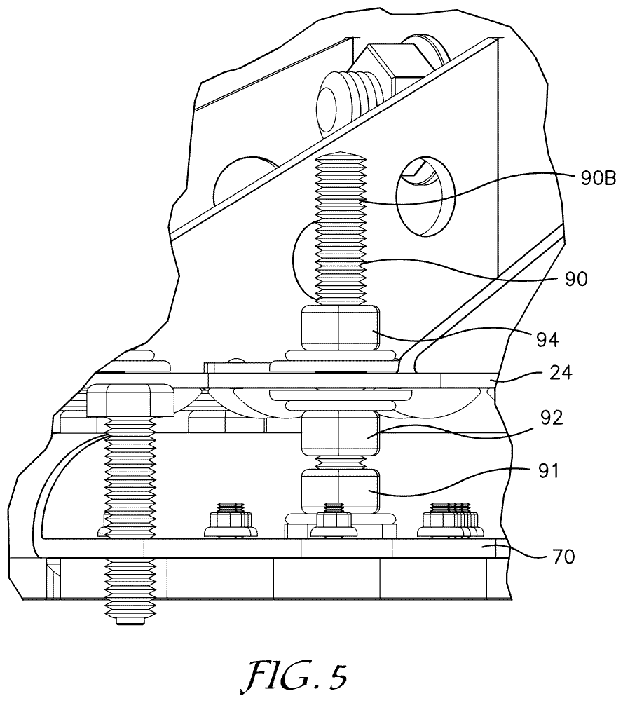

The trays 70 as illustrated at FIGS. 2 and 5 are mounted to the base plate 24 using fasteners 90. The fasteners 90 extend through both the trays 70 and longitudinally extending slots 89 in the base plate 24 thereby allowing positional adjustment of the trays 70 relative to the base plate 24. As best illustrated at FIG. 4, the head 90A of the fastener 90 is preferably positioned beneath the tray 70 and is in contact with the lower surface 78. As illustrated at FIG. 5, the shaft 90B of the fastener 90 extends upward, through and beyond the slot 89 in the base plate 24 and terminates above the upper surface 26 of the base plate.

As illustrated at FIGS. 3 and 5, to prevent the fastener 90 from pulling the upper edges 86, 88 of the trays 70 into contact with the lower surface 28 of the base plate 24 and to optimally provide some measure of control over the orientation of the trays 70 relative to the base plate 24 a first spacing nut 91 is threaded onto the shaft 90B of the fastener 90 and positioned atop the upper surface 76 of the tray 70. Next, a second spacing nut 92 is threaded onto the fastener 90 and is spaced apart from the installed first spacing nut 91. Finally, when the desired spacing between the first and second spacing nuts 91, 92 is achieved, a third nut 94 is threaded onto the fastener 90 and rests atop the base plate 24 securing the fastener 90 into position.

As illustrated at FIG. 5, the precise placement of each of the nuts 91, 92, 94 along the shaft 90B of the respective fasteners 90 dictates the inclination of the tray 70 relative to the base plate 24. Adjustment of the nuts 92, 94 higher, lower, closer or further apart from one another on the fastener shaft 90B facilitates inclination of the tray 24 for purposes of alignment with the upper surface 14 of the water tower 16. The significance of having proper alignment of the plurality of trays 70 with the upper surface 14 of the water tower 16 is critical to optimize the pull of the plurality of high-performance magnets.

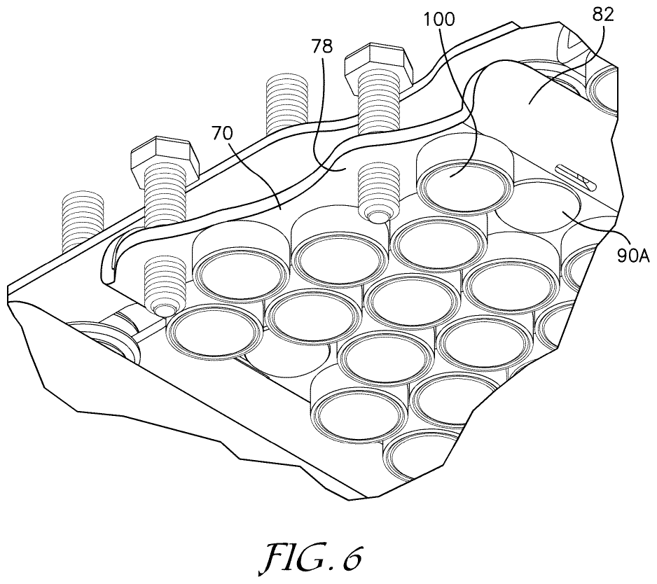

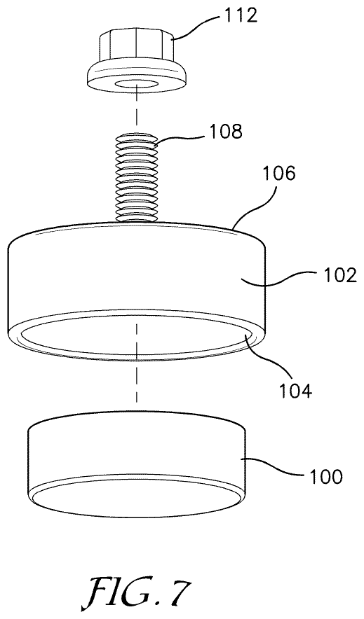

As best illustrated at FIG. 6, mounted beneath the lower surface 78 of each of the of trays 70 are a plurality of magnets 100. A preferred embodiment of the magnetic mounting hardware 10 utilizes eighty (80) magnets disposed beneath each tray 70; however, the number of magnets per tray 70 may be greater or lesser depending upon the application and the demand for magnetic holding power. As illustrated at FIG. 7, the magnets 100 preferred for this application are neodymium (rare earth) disc magnets that also are preferably securely potted inside of a metal cup 102 and fully surrounded on the circumference of the entire magnet 100 with epoxy 104. A preferred “maximum energy product” designation for the magnets is N42 as they provide high performance at an economical price.

As illustrated at FIG. 7, extending outwardly from the base 106 of each metal cup 102 is a threaded extension 108. Starting at the lower surface 78, the threaded extension 108 is passed through an opening (not shown) in the tray 70 and once above the upper surface 76 a nut 112 is threaded to the extension 108 securing the neodymium disc magnet 100 immersed in cup 102 with epoxy 104 against the lower surface 78 of the tray 70. The multitude of these powerful rare earth magnets 100 mounted to the magnetic mounting hardware 10 provides tremendous power of attraction to the upper surface 14 of the water tower 16.

The magnetic pulling power of these hundreds of magnets 100 can lead to challenges in mounting and removing the magnetic mounting hardware 10. As the distance between the magnets 100 and the upper surface 14 of the water tower 16 decreases the magnetic attraction increases. This is because the magnetic field strength increases with decreasing distance. The closer the magnet is to the surface, the stronger the magnetic force will be.

While many factors enter into the determination of the magnetic pull force to include the type and thickness of the steel utilized on the water tower, the direction of the applied force, the ambient temperature, moisture and whether any coating systems are utilized, the pulling power of the disclosed embodiments of the hardware system 10 is significant. Performance testing has confirmed a force exceeding 5,000 pounds applied perpendicularly to the metal surface is required to extract the hardware 10 when eighty rare-earth magnets 100 are utilized per tray 70 with a total of four trays in use. Consequently, when placing the hardware 10 near the metal surface, care must be taken to prevent the nearly instantaneous and powerful attraction of the magnets to the surface that could cause incorrect placement of the hardware upon the surface or result in injury.

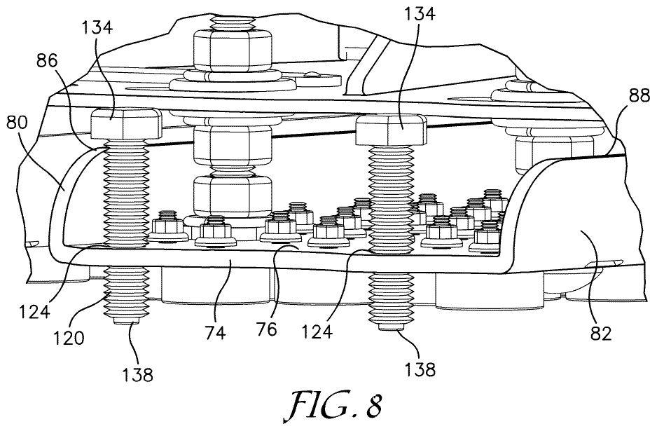

To address this concern, the disclosed hardware 10 utilizes hover bolts 120. In a preferred embodiment of the hardware 10, and as disclosed at FIGS. 2 and 8, a total of sixteen (16) hover bolts 120 are utilized (four per tray); however, a lesser and greater number of hover bolt assemblies are contemplated by this disclosure and may be equally effective. At least one, and preferably two, through holes 124 are placed in each of the trays 70 at the longitudinally opposed first and second ends 72, 74. A preferred embodiment of the hover bolt is a 2-inch long, ½0 inch-13 stainless steel bolt; however, other lengths and diameters are contemplated by this disclosure.

As illustrated at FIG. 8, the tips 138 of the threaded hover bolts 120 are preferably coated with a cushioning material, such as an engineered polymer, that serves to prevent marring, penetration or damage to any protective coatings that may be applied to the upper surface 14 of the water tower 16. In a preferred embodiment, the through holes 124 are tapped (threaded) to receive the hover bolt 120 with a head 134. The hover bolts 120 are positionally available without obstruction for manual adjustment; however, when removing the magnetic mounting hardware 10 from the surface 14 of the tower 16, tools may be required to turn the head 134 of the bolt 120 due to the significant holding power of the assembled magnets 100.

In operation, before mounting the disclosed hardware 10 to the upper surface 14 of the water tower 16, the hover bolts 120 are rotatably extended downward to their fullest extension thereby equalizing the extension of all the hover bolts 120. In addition, the inclination of each of the trays 70 and the associated magnets 100 should be optimally aligned with the surface to which it is to contact to achieve maximum pulling power of the employed magnets 100.

As previously detailed, to control orientation of the trays 70 and associated magnets 100 relative to the base plate 24, the three spacing nuts 91, 92, 94 threaded to the fasteners 90 are adjusted up and down to raise and lower as necessary areas of the tray 70 to achieve tray 70 inclination consistent with the topography of the upper surface 14 of the water tower 16. To achieve the desired inclination of the trays 70 may require some nominal level of experimentation with the position of the spacing nuts 92, 94 on the threaded fastener 90. To achieve the desired optimal alignment of the trays to the upper surface 14 may require adjustment of the connection of the kick-blade assembly 49 to the securement members 34, 36 as is discussed below.

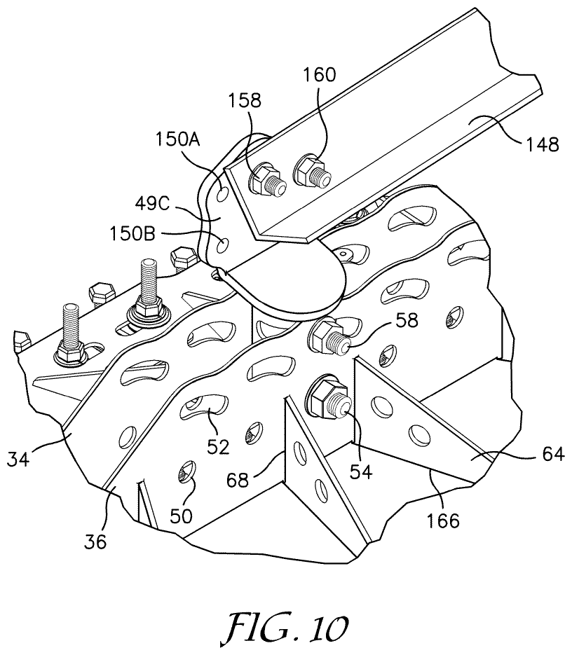

In an embodiment of the magnetic mounting hardware 10 as illustrated at FIGS. 9A, 9B and 9C, utilizes a two-part system identified as a kick-blade assembly 49. The kick-blade assembly 49 includes a kick-blade tube 49A, an insert pipe 49B that is preferably hot glued or otherwise temporarily held in position between the span S between the securement members 34, 36. The kick-blade assembly 49 is capable of rotating about the vertical Z-Axis which is an important attribute allowing the kick-blade assembly 49 (as illustrated at FIG. 10) to accommodate any angle of attachment hardware that is used when, for example, a structural support member 148 such as a pipe tube or angle iron member is mounted to the kick-blade assembly 49 by using any assortment of the openings 150A, 150B, 154, 162 in the paddle 49C. The choice provided by the through hole pattern 150A, 150B, 154, 162 facilitates vertical displacement of the structural support member 148 on the blade paddle 49C while the center slot 154 is employed for retaining a single fastener 158. A separate fastener 160 may also be inserted into the crescent shaped slot 162 providing additional holding power.

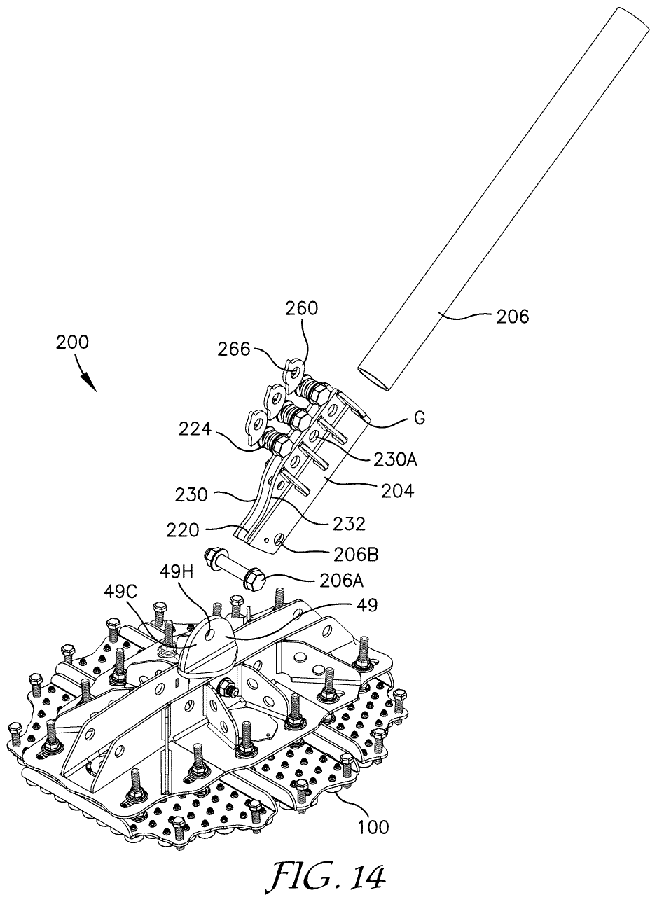

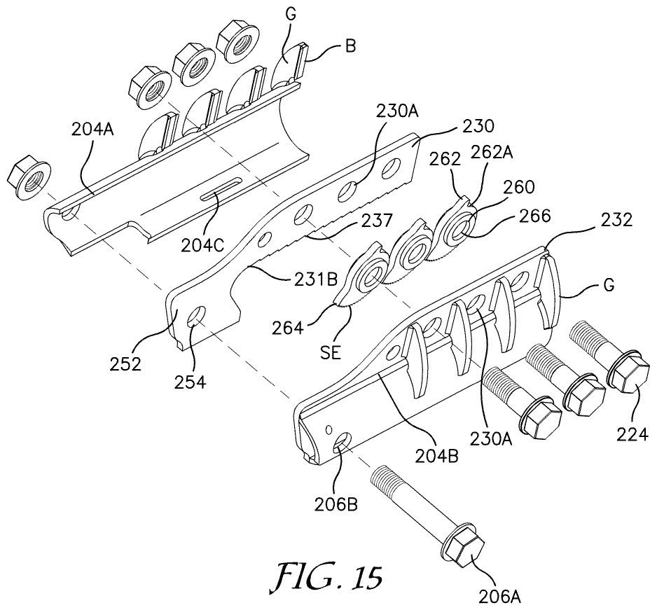

Additionally disclosed herein and as illustrated at FIGS. 14 and 15, is a fastening system 200 that serves to connect a structural tube 206 of the roof corral 12 to the paddle 49C of the kick-blade assembly 49 with a threaded fastener 206A passing through an opening 49H in the paddle. The fastening system 200 comprises a collar 204 that encircles an end portion of a structural tube 206. The collar 204 includes a longitudinally extending slot 220 that has two longitudinally extending opposed edges 204A, 204B. In addition, there are a plurality of upwardly extending gussets G, each with a backstop surface B that are positioned so that the backstop surface is flush with the opposed edges 204A, 204B. The base of the steel gussets G are secured, preferably by welding, to the outer surface of the collar 204.

As illustrated at FIG. 15, the disclosed fastening system 200 also utilizes first and second grip plates 230, 232. The grip plates are preferably fabricated from steel and have a thickness in the range of about 0.125 inches to 0.375 inches. The grip plates also have a lower edge 231B with a significant longitudinally extending portion that is serrated 237. The grip plates 230, 232 include at least one aligned through hole 230A, and a distal end 252 with at least one through hole 254 therein. The grip plates 230, 232 are secured respectively to the first and second slot edges 204A, 204B and to the backstop surfaces B of the plurality of gussets G proximate the first and second slot edges 204A. The preferred means of securing the gussets G to the first slot edge 204A and the backstop surface B is by metal welding so that maximum holding power may be obtained.

As illustrated at FIG. 15, at least one fastener 224 is passed through aligned through holes 230A of the first and second grip plates 230, 232. The tightening of the at least one fastener 224 drives the lower serrated edge 237 of the first and second grip plates 230, 232 into the surface of an inserted structural tube 206 and increasingly compresses the interior surface of the collar 204 against the outer surface of the structural tube. This increasing compression by the collar 204 is accomplished because the grip plates 230, 232 are held in position by being welded respectively to the gussets G and to the longitudinally extending opposed edges 204A, 204B.

The tightening of the fasteners 224 pulls the two grip plates 230, 232, and in turn the first and second slot edges 204A, 204B toward one another thereby greatly increasing the pressure applied to the structural tube 206. FIG. 15 should not be interpreted to suggest that the entire collar is cut longitudinally but is shown as split to convey that the grip plates 230, 232 are positioned within the slot 220 and to clearly illuminate the position of other components within the assembly. The fastening system 200 as revealed at FIG. 15 also illustrates a weep hole 204C opposite the slot 220 to allow rainwater collected within the collar 204 to escape.

As further illustrated at FIG. 15, the fastening system 200 may also optionally utilize one or more steel pawl grips 260 that are retained between the first and second grip plates 230, 232 to provide a supplemental grip upon the structural tube 206. The pawl grip 260 has a center body through hole 266 and in all embodiments at least one fin 264 that extends outwardly. The fin 264 preferably has serrations SE on an outer surface that is rotatably positioned into contact with the structural tube 206 to enhance the holding power of the collar 204. In other embodiments, such as that illustrated at FIG. 15, a second fin 262 may be utilized that is positioned approximately 180 degrees opposite the first fin 264.

A tool, such as a screwdriver, may be utilized by placing the tip of the screwdriver at the base 262A of the second fin 262 and upon striking the handle of the screwdriver, the entire pawl grip rotates driving the serrations of the first fin 264 into the surface of the structural tube 206. The same fasteners 224 that pass into openings 230A in the grip plates 230, 232 are also employed to retain the pawl grips 260 in position. It is contemplated that more than one pawl grip 260 may be utilized in the fastening system 200.

Test data reveals that each grip-pawl 260 provides an expected pull-out resistance tensile force of about 4,000 lbs. The expected total pull-out tensile force with three grip-pawls 260 in position and the serrations 237 of the grip plates 230, 232 embedded in the structural tube 206, with all three fasteners 224 fully torqued is approximately 40,000-80,000 lbs. for galvanized steel pipe with an outside diameter of 2.375 inches.

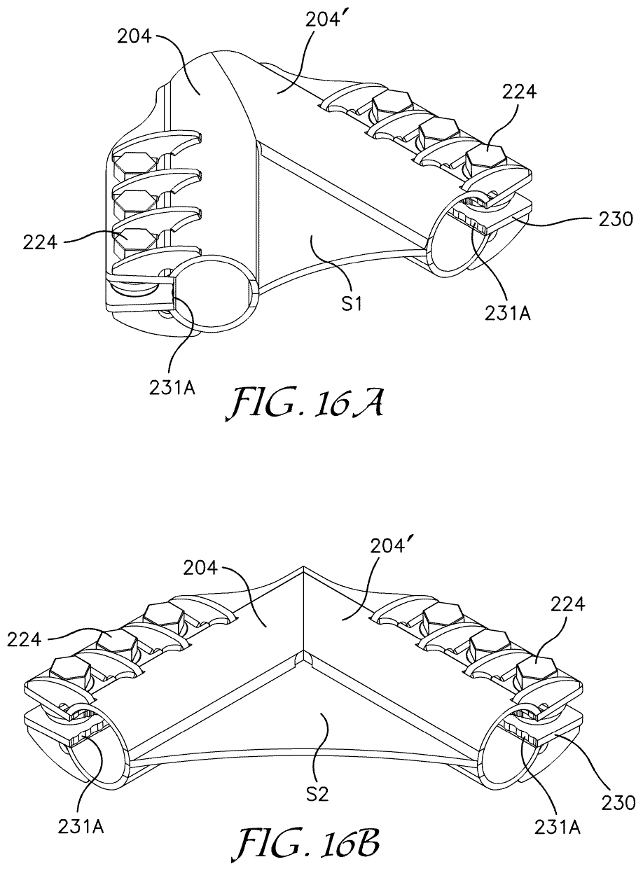

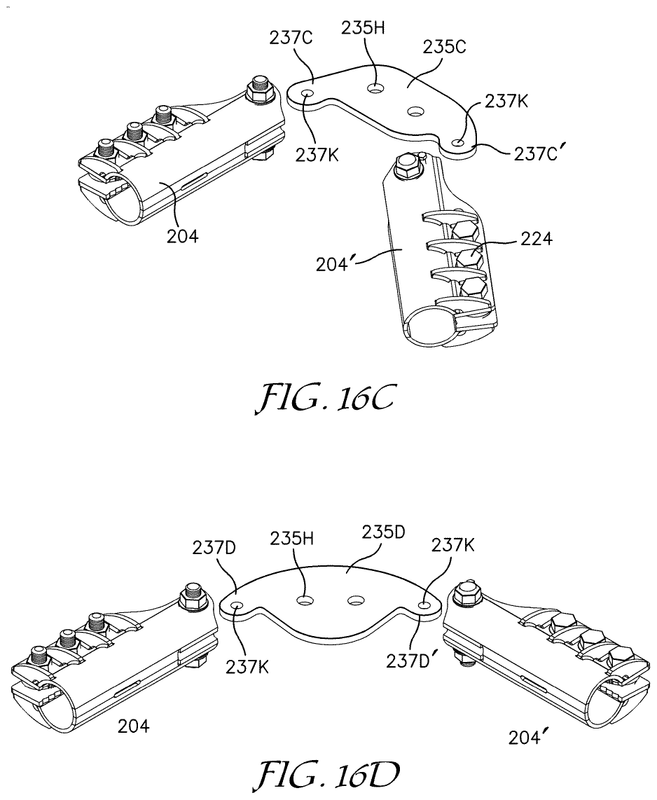

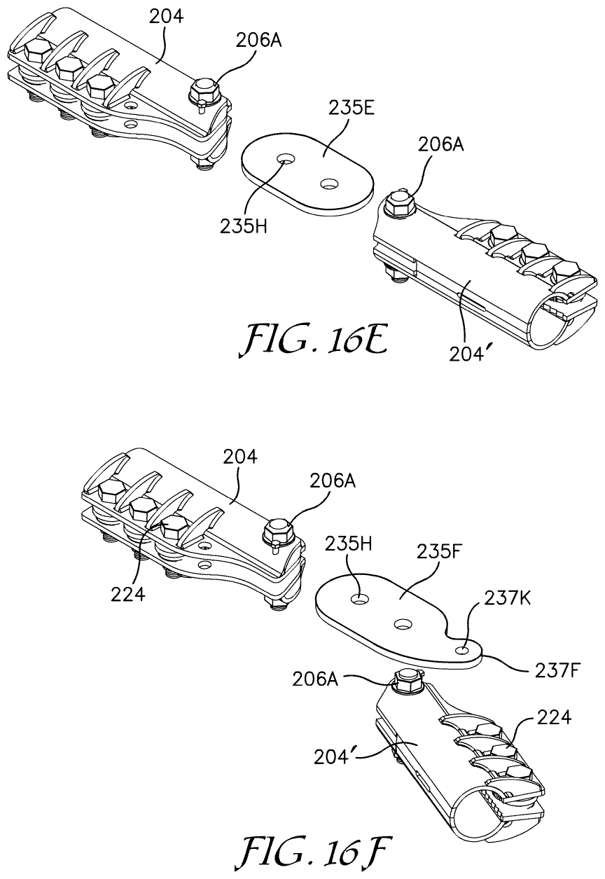

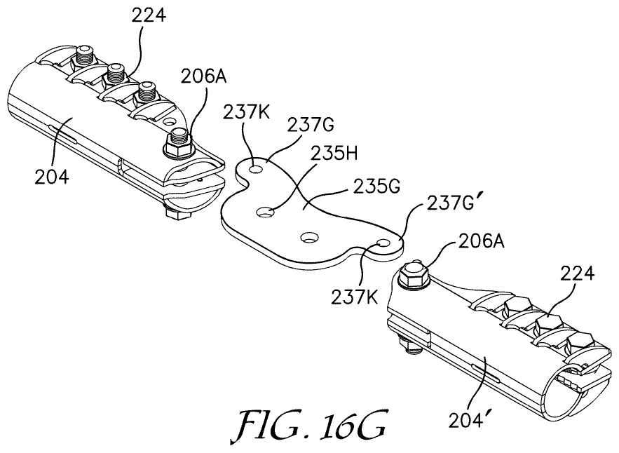

As previously disclosed, the grip plates 230, 232 employ an outwardly extending distal end 252 that includes at least one opening 254 that is aligned with one or more openings 206B at the distal end of the collar 204 that are used to anchor the collar 204 and the associated structural tube 206 with a grip plate fastener 206A to another member, such as the kick-blade paddle 49C. FIGS. 16A-16B illustrate how two collars 204 can be joined, preferably by welding, them together at respectively 45- and 90-degree orientations. Stiffener plates S1, S2 are cut according to the desired angle, i.e., 45- or 90-degrees and are welded into position against the lower surfaces of the collars 204. The stiffener plates S1, S2 provide considerable resistance to bending which may be highly desired in certain roof corral 12 configurations.

FIGS. 16C-16G detail the role of various configurations of accessory plates 235C-235G. These accessory plates are used in fastening the distal ends of the collars 204 together. The disclosed accessory plates 235C-235G provide a small sampling of the wide range of possible accessory plates that are employable to connect the collars 204 and enveloped end sections of structural tubes 206 to one another using fasteners passing through openings in the accessory plates.

The accessory plates are preferably fabricated from steel with a thickness in the range of 0.375 to 0.50 inches. Various features such as protruding extensions 237C, 237C′, 237D, 237D′, 237F, 237G, 237G′ on accessory plates 235C-235G are utilized to limit movement of the collars 204 by providing through holes 237K in the protruding extensions to secure the collars 204 in position with fasteners passing through the holes in the extensions and also passing through the one or more openings 254 in the distal end 252 of the grip plates 230, 232. Additional openings 235H in the accessory plates 235C-235G are employed for attachment to other structural members as required by the installation engineer.

The disclosed fastening system 200 is functionally superior to existing hardware that utilizes U-bolt connections or angle iron attachments because of the flexibility of the system to accommodate the length of engagement between the collar 204 and the tube 206 and the wide range of orientations of the angle of connection between the adjacent structural tubes 206. The disclosed fastening system 200 is capable of a wide range of orientations because of the single point of fastening 206A, 206B and exhibits a greatly increased slip-critical pull-out force. The system also provides excellent resistance to rotation of the inserted structural tube 206.

The holding power of the collar 204 may be increased, for example, when the collar 204 is hot dip galvanized, due to enhanced roughness of the galvanized steel. The disclosed system 200, which in a preferred embodiment utilizes a 2.375-inch diameter Schedule 40 galvanized steel structural tube 206 inserted approximately 7.33 inches into the collar 204 provides in the range of 50-60 square inches of surface contact with the structural tube 206. Other diameters of structural tube 206 will, of course, have a different amount of surface area contact.

When in position the kick-blade tube 49A can rotate along two sets of knurled channels 170A, 170B, 170C and 170D. The insert pipe 49B is received into the interior space 144 of the kick-blade tube 49A and is critical for preventing movement of the paddle 49C. The insert pipe 49B has an outside diameter slightly less than the inside diameter 174 of the kick-blade tube 49A to prevent interference during insertion of the insert pipe 49B.

As illustrated at FIGS. 9A and 10, when the kick-blade assembly 49 is fully assembled and in position between the securement members 34, 36 a first threaded fastener 58 is passed through the slot 52 in the first securement member 34, through the two upper channels 170A, 170C in the kick-blade tube 49A, into an upper opening 60B in the insert pipe 49B and then out through the slot 52 in the second securement member 36 where a nut 58A is fastened to prevent the fastener 58 from being withdrawn. A preferred fastener 58 for this application is a ⅝-inch×7-inch zinc hex bolt.

The kick-blade assembly 49 is further retained in position between the first and second securement members 34, 36 with the aid of a second fastener 54 that passes into the through hole 50 in the first securement member 34 then through the two lower channels 170B, 170D in the kick-blade tube 49A, into the lower opening 60A in the insert pipe 49B and then out the through hole 50 in the second securement member 36 where a nut 54A is fastened to prevent the fastener 54 from being withdrawn. A preferred fastener 54 for the lower point of attachment are ¾-inch×7-inch zinc hex bolts.

Once the kick-blade assembly 49 is in position between the securement members 34, 36 the installer can connect the structural support member 148 to the blade paddle 49C on either the left or right side of the magnetic mounting hardware 10. If the structural support member 148 is too long and overextends the kick-blade paddle 49C for connection purposes, the installer has the option to rotate the kick-blade tube 49A by 180 degrees thereby providing increased clearance. Additionally, the plurality of upper slots 52 and lower holes 50 in the securement members 34, 36 provide considerable positional flexibility for placement of the kick-blade assembly 49 atop the base plate 24.

As best illustrated at FIG. 1, a plurality of the magnetic mounting hardware 10 are utilized on the roof corral 12. FIG. 1 illustrates a total of sixteen (16) magnetic mounting hardware units 10 secured to the roof corral 12; however, a greater or lesser number of magnetic mounting hardware units 10 per roof corral 12 are contemplated by this disclosure. Each magnetic mounting hardware 10 unit provides considerable holding power for the roof corral 12 and the associated telecommunications hardware 20.

The magnetic mounting hardware units 10 may optionally be attached to the roof corral 12 using the highly adaptable kick-blade assemblies 49 that each include a kick-blade tube 49A with a paddle 49C, an insert pipe 49B and structural support members 148. The fully assembled roof corrals 12 and the associated magnetic mounting hardware units 10 are preferably lifted by a crane into position atop the upper surface 14 of the water tower 16.

Prior to engagement with the upper surface 14, the hover bolts 120 are advanced downward to their fullest extent thereby preventing inadvertent attachment of the mounting hardware 10 to the upper surface 14. Additionally, the inclination of each of the trays 70 residing beneath the base plate 24 are adjusted by means of the inclination hardware 90, 90B, 92, 94 to match the topography of the upper surface 14. Once the inclination of the trays 70 are fully aligned to the topography of the upper surface 14 the hover bolts 120 are rotatably withdrawn above the level of the magnets 100 by rotation of the heads 134. Once the hover bolts 120 are all withdrawn above the level of the magnets 100, the corral 12 and along with the magnetic mounting hardware 10 can be lowered into position and fixedly positioned atop the upper surface 14 by the power of the associated magnets 100.

The disclosed magnetic mounting hardware should not be construed as limiting in any way. Instead, the present disclosure is directed toward all novel and nonobvious features and aspects of the various disclosed embodiments, alone and in various combinations and sub-combinations with one another. The disclosed apparatus and systems are not limited to any specific aspect or feature or combination thereof, nor do the disclosed embodiments require that any one or more specific advantages be present, or problems be solved.

In view of the many possible embodiments to which the principles of the disclosed invention may be applied, it should be recognized that the illustrated embodiments are only examples of the disclosure and should not be taken as limiting the scope of the invention. Rather, the scope of the invention is defined by the following claims. I therefore claim as my invention all that comes within the scope of these claims.

The disclosure presented herein is believed to encompass at least one distinct invention with independent utility. While the at least one invention has been disclosed in exemplary forms, the specific embodiments thereof as described and illustrated herein are not to be considered in a limiting sense, as numerous variations are possible. Equivalent changes, modifications, and variations of the variety of embodiments, materials, compositions, and methods may be made within the scope of the present disclosure, achieving substantially similar results. The subject matter of the at least one invention includes all novel and non-obvious combinations and sub-combinations of the various elements, features, functions and/or properties disclosed herein and their equivalents.

Benefits, other advantages, and solutions to problems have been described herein regarding specific embodiments. However, the benefits, advantages, solutions to problems, and any element or combination of elements that may cause any benefits, advantage, or solution to occur or become more pronounced are not to be considered as critical, required, or essential features or elements of any or all the claims of at least one invention.

Many changes and modifications within the scope of the instant disclosure may be made without departing from the spirit thereof, and the one or more inventions described herein include all such modifications. Corresponding structures, materials, acts, and equivalents of all elements in the claims are intended to include any structure, material, or acts for performing the functions in combination with other claim elements as specifically recited. The scope of the one or more inventions should be determined by the appended claims and their legal equivalents, rather than by the examples set forth herein.

Benefits, other advantages, and solutions to problems have been described herein regarding specific embodiments. Furthermore, the connecting lines, if any, shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

In the detailed description herein, references to “one embodiment,” “an embodiment,” “an example embodiment,” etc., indicate that the embodiment described may include a feature, structure, or characteristic, but every embodiment may not necessarily include the feature, structure, or characteristic. Moreover, such phrases are not necessarily referring to the same embodiment. Further, when a feature, structure, or characteristic is described relating to an embodiment, it is submitted that it is within the knowledge of one skilled in the art to affect such feature, structure, or characteristic relating to other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The invention has been described above with reference to one or more preferred embodiments, it will be appreciated that various changes or modifications may be made without departing from the scope of the invention as defined in the appended claims.

I claim:

1. A magnetic mounting system for securing a roof corral to a ferromagnetic structure, comprising:
a base plate;
a plurality of magnets coupled to the base plate for magnetically securing the base plate to the ferromagnetic structure;
first and second spaced-apart securement members secured to the base plate;
a kick-blade assembly positioned between the first and second securement members, the kick-blade assembly including a kick-blade tube and a paddle coupled to the kick-blade tube;
a kick-blade tube retention assembly including (i) at least one arcuate slot defined in the base plate and (ii) at least one tab extending downwardly from a lowermost edge of the kick-blade tube and received in the at least one arcuate slot, wherein the at least one tab when received into the at least one arcuate slot provides lateral stability to the kick-blade tube retention assembly to resist lateral movement relative to the base plate; and
a fastening system coupling a structural tube of the roof corral to the paddle, the fastening system including:
a collar configured to receive an end portion of the structural tube, the collar having a longitudinally extending slot with opposed first and second slot edges;
a plurality of spaced apart gussets secured proximate each of the opposed first and second slot edges, the plurality of gussets each comprising a backstop surface flush with and extending upwardly from the first and second opposed slot edges;
a first grip plate with a lower serrated edge, at least one through hole, and a distal end, the first grip plate secured to the first slot edge and to the backstop surfaces of the plurality of gussets secured to the collar adjacent the first slot edge;
a second grip plate with a lower serrated edge, at least one through hole aligned with the through hole of the first grip plate, and a distal end, the second grip plate secured to the second slot edge and to the backstop surfaces of the plurality of gussets secured to the collar adjacent the second slot edge; wherein
at least one fastener is passed through the at least one aligned through hole of the first and second grip plates, wherein tightening the fastener draws the first grip plate and the second grip plate toward one another to compress the collar about the structural tube and clamp the collar to the structural tube, and wherein the compression causes at least one serrated edge of at least one of the grip plates to bite into an outer surface of the structural tube.

2. The system of claim 1, wherein a pawl grip is retained between the first and second grip plates to provide a supplemental grip upon the structural tube, the pawl grip including a center portion with a through hole therein and a fin extending outwardly from the center portion, the fin having serrations on a surface that is rotatable about an axis of the through hole into contact with the structural tube.

3. The system of claim 1, wherein the first and second grip plates are secured respectively to the opposed first and second slot edges and to the backstop surfaces of the plurality of gussets disposed proximate the first and second slot edges by welding.

4. The system of claim 1, wherein the distal end of the first and second grip plates includes at least one through hole aligned for connection to the paddle with a fastener.

5. The system of claim 1, wherein the kick-blade tube retention assembly comprises two oppositely disposed tabs extending downwardly from the lowermost edge of the kick-blade tube and two arcuate slots in the base plate respectively receiving the two tabs.

6. The system of claim 5, wherein each tab has an arc in a range of 35 to 45 degrees.

7. The system of claim 5, wherein each arcuate slot has a curvature in a range of 135 to 145 degrees.

8. The system of claim 1, wherein each tab extends through substantially an entire thickness of a corresponding arcuate slot in the base plate.

9. The system of claim 1, wherein the base plate defines multiple sets of arcuate slots, and further comprising at least one lock-out tag positioned over at least one arcuate slot to prevent insertion of the tab into that arcuate slot.

10. The system of claim 9, wherein the at least one lock-out tag is secured to the base plate by a threaded fastener anchored in the base plate.

11. The system of claim 9, wherein the at least one lock-out tag comprises a metallic tag coupled to the base plate by a tag fastener and includes a high contrast color relative to the base plate and a warning message indicating that installation is not permitted at the arcuate slot covered by the lock-out tag

12. A collar assembly for coupling a structural tube to a structural member, comprising:
a collar configured to receive an end portion of the structural tube, the collar including a longitudinally extending slot with opposed first and second slot edges;
a plurality of spaced apart gussets secured proximate each of the opposed first and second slot edges, the plurality of gussets having a backstop surface flush with and extending upwardly from the first and second opposed slot edges;
a first grip plate with a lower serrated edge, a distal end and at least one through hole, the first grip plate secured to the first slot edge and to the backstop surface of the plurality of gussets proximate the first slot edge;
a second grip plate with a lower serrated edge, a distal end, at least one through hole aligned with the through hole of the first grip plate, the second grip plate secured to the second slot edge and to the backstop surface of the plurality of gussets proximate the second slot edge; wherein
at least one fastener is passed through the at least one aligned through hole of the first and second grip plates, wherein tightening of the fastener drives the lower serrated edge of both the first and second grip plates into an outer surface of an inserted structural tube and compresses an interior surface of the collar into contact with the exterior surface of the structural tube.

13. The collar assembly of claim 12, wherein the grip plate has a thickness in a range of 0.125 to 0.375 inches.

14. A kick-blade tube retention assembly for a magnetic mounting apparatus, comprising:
a base plate configured to support a magnetic mounting assembly;
at least one arcuate slot defined in the base plate; and
a kick-blade tube having a lowermost edge and at least one tab extending downwardly from the lowermost edge, the at least one tab being received within the at least one arcuate slot, wherein
the at least one tab and the at least one arcuate slot along with the lowermost edge of the kick-blade tube maintaining contact with the base plate serve to laterally stabilize the kick blade tube.

15. The kick-blade tube retention assembly of claim 14, wherein the kick-blade tube includes two oppositely disposed tabs and the base plate includes two arcuate slots respectively receiving at least two tabs.

16. The kick-blade tube retention assembly of claim 14, wherein each tab has an arc in a range of 35 to 45 degrees.

17. The kick-blade tube retention assembly of claim 14, wherein each arcuate slot has a curvature in a range of 135 to 145 degrees.

18. The kick-blade tube retention assembly of claim 14, wherein the base plate includes multiple sets of arcuate slots, and further comprising at least one lock-out tag positioned over at least one arcuate slot other than the selected arcuate slot, the at least one lock-out tag configured to obstruct insertion of the at least one tab into the at least one arcuate slot covered by the lock-out tag.

19. The kick-blade tube retention assembly of claim 18, wherein the at least one lock-out tag is metallic and is secured to the base plate with a threaded fastener anchored in the base plate.

20. The kick-blade tube retention assembly of claim 18, wherein the at least one tab extends through substantially an entire thickness of the at least one arcuate slot of the base plate.

21. A magnetic mounting apparatus, comprising:
a center base plate;
a plurality of magnets coupled to the center base plate and configured to magnetically secure the apparatus to a ferromagnetic structure; and
first and second lateral sections disposed on opposite sides of the center base plate, wherein the center base plate is configured such that (i) the first and second lateral sections are canted downwardly relative to the center base plate, or (ii) the center base plate and the first and second lateral sections collectively form a continuous curved profile.

22. The magnetic mounting apparatus of claim 21, wherein the first and second lateral sections are canted downwardly relative to the center base plate at an angle of about 5 degrees.

23. The magnetic mounting apparatus of claim 21, wherein the plurality of magnets are arranged beneath at least one of the center base plate and the first and second lateral sections.
